(19) United States
(12) Patent Application Publication
(10) Pub. No.: US 2026/0192362 A1
(43) Pub. Date: Jul. 9, 2026

(54) Powder Bed Fusion Build Plates Restoration with Friction Surfacing Additive Manufacturing (FSAM)

(71) Applicant: RTX Corporation, Farmington, CT (US)

(72) Inventors: Lawrence Binek, Glastonbury, CT (US); Jesse Boyer, Middletown, CT (US); Benjamin Gardell, Bristol, CT (US); Dean Sirois, Enfield, CT (US)

(21) Appl. No.: 19/550,809

(22) Filed: Feb. 26, 2026

Related U.S. Application Data
(63) Continuation-in-part of application No. 18/345,835, filed on Jun. 30, 2023.

(51) Int. Cl. B22F 10/43; B22F 10/28; B33Y 10/00; B33Y 30/00; B33Y 70/00; B33Y 80/00

(52) U.S. Cl. CPC B22F 10/43; B22F 10/28; B33Y 10/00; B33Y 30/00; B33Y 70/00; B33Y 80/00

(57) ABSTRACT

A build plate for a powder bed fusion-laser (PBF-L) additive manufacturing system has a support region and a top region. The top region is formed on the support region by a friction surfacing additive manufacturing (FSAM) process, such that the top region is under a compressive stress. The build plate can be prepared by preparing the build plate support region to receive the top region and depositing, using a FSAM process, a layer of metal on the support region. The layer of metal is formed with a compressive stress to form the top region. The top region is then machined to provide a desired surface roughness.

### CROSS-REFERENCE TO RELATED APPLICATION

This application is a continuation-in-part of commonly-owned U.S. patent application Ser. No. 18/345,835 filed on Jun. 30, 2025 and directed to Resilient Build Plates for Powder Bed Fusion-Laser Additive Manufacturing, the disclosure of which is hereby incorporated by reference in its entirety.

### BACKGROUND

The present disclosure relates generally to laser powder bed fusion additive manufacturing and, more particularly, to build plates for use with a laser powder bed fusion additive manufacturing system.

Powder bed fusion-laser (PBF-L) additive manufacturing is an additive manufacturing, or 3-D printing, technology that uses a laser to sinter or fuse metallic or polymeric particles together in a layer-by-layer process. PBF-L is typically used as an industrial process to make near net shape parts. Some PBF-L processes sinter the build powder particles, while others melt and fuse the build powder particles. PBF-L is also known as direct metal laser sintering (DMLS).

Build plates serve as a foundation upon which a PBF-L build is built. As the PBF-L build (i.e., the “workpiece” or “part”) is built, the workpiece is effectively welded onto the build plate. For larger geometry parts, build plates can warp due to tensile stresses induced in the build plate by the workpiece. At times, the build can have sufficient internal thermal stress that it will cause a tensile failure within the build plate. Additionally, large regions of consolidate build powder on the build plate can cause build plate spallation, which can result in a failed build.

### SUMMARY

One aspect of this disclosure is directed to a build plate for a powder bed fusion-laser (PBF-L) additive manufacturing system, which has a support region and a top region. The top region is formed on the support region by a friction surfacing additive manufacturing (FSAM) process, such that the top region is under a compressive stress.

Another aspect of the disclosure is directed to a method of preparing a build plate for use in a PBF-L additive manufacturing system. A support region of the build plate is prepared to receive a top region and a layer of metal is deposited, using a FSAM process, on the support region. The layer of metal is formed with a compressive stress to form the top region. The top region is then machined to provide a desired surface roughness.

Yet another aspect of this disclosure is directed to another method of preparing a build plate for use in a PBF-L. One or more builds formed on the build plate during a first PBF-L additive manufacturing campaign are removed from the build plate to expose a support region and defects formed in the build plate as a result of removing the one or more builds from the build plate are repaired. The support region of the build plate is prepared to receive a top region and a layer of metal is deposited, using a FSAM process, on the support region. The layer of metal is between 0.020 inches and 0.030 inches thick and is formed with a compressive stress to form the top region. The top region is then machined to provide a desired surface roughness. The build plate is installed in the PBF-L additive manufacturing system and the top region is polished by a laser in the PBF-L additive manufacturing system before build powder is deposited on top of the top region to start a second PBF-L additive manufacturing campaign.

### BRIEF DESCRIPTION OF THE DRAWINGS

FIG. 1 is a schematic of an exemplary powder bed fusion-laser (PBF-L) additive manufacturing system.

FIG. 2 is photograph of a part made on a PBF-L additive manufacturing system of FIG. 1.

FIG. 3 is a schematic of a build plate that is the subject of this disclosure.

FIG. 4 is a block diagram of an exemplary computer numerical control (CNC) machine system useful for Friction Surface Additive Manufacturing (FSAM) process consistent with this disclosure.

FIG. 5A is a perspective view of an exemplary spindle attachment useful with the CNC machine system of FIG. 4.

FIG. 5B is a cross-sectional view of the spindle attachment shown in FIG. 5A taken along line B-B in FIG. 5A.

FIG. 6 is a schematic depicting a FSAM process consistent with this disclosure.

FIG. 7A is a perspective view of an exemplary build plate consistent with this disclosure.

FIG. 7B is a perspective view of another exemplary build plate consistent with this disclosure.

FIG. 7C is a perspective view of yet another exemplary build plate consistent with this disclosure.

FIG. 8 is a schematic view of an annular build plate consistent with this disclosure.

FIG. 9 is a schematic of a build plate that includes temperature control features.

### DETAILED DESCRIPTION

Powder bed fusion-laser (PBF-L) additive manufacturing is an option to make near net shape parts. The dynamic, high temperature, high energy processes conditions that are characteristic of PBF-L additive manufacturing processes result in a PBF-L build (i.e., the “workpiece” or “part”) being effectively welded onto the build plate of the PBF-L system. For larger geometry workpieces, build plates can warp due to tensile stresses induced in the build plate by the workpiece. At times, the build can have sufficient internal thermal stress that it will cause a tensile failure within the build plate. Additionally, large regions of consolidate build powder on the build plate can cause build plate spallation, which can result in a failed build.

Another challenge with PBF-L systems is that the material used for build plates must be metallurgically compatible with the material used for the workpiece. Often this means that the build plates must be constructed from the same or similar material as the workpiece. For example, aluminum builds typically require aluminum build plates, titanium builds typically require titanium build plates, etc. As titanium is a relatively expensive material, titanium build plates are expensive. The expense is proportional to the size of the build plate so as PBF-L systems are scaled for industrialization, the build plates will become bigger (currently upwards of 600 mm²) further driving up cost of the process.

Further, thermal loading that occurs during a PBF-L build process induces tensile stresses in the build plates. Because the amount of consolidated mass in a build is proportional to the tensile stresses generated in the build plate, large bulky builds are often at risk of damage due to build plate warping or failure. Large bulky builds can take a very long time (e.g., as much at one month or more) and the risk of failure in the build plate increases during the build because the consolidated mass of the build increases as the build progresses towards completion. As a result, the cost of failure for such builds can increase as the build progresses towards completion.

In addition to the failure modes discussed above, PBF-L build plates require machining after a built part has been removed. Typically, the build plate is either milled or ground flat to be reused. Eventually the plate may have to be condemned due either to the plate becoming too thin from repeated re-uses or the plate becoming embrittled as a result of being exposed to too many stress relief cycles.

This disclosure describes a method of preparing build plates for use or reuse by forming a top region on top of a build plate support region using a friction surfacing additive manufacturing (FSAM) process, sometimes referred to as a friction stir additive manufacturing process, to rebuild the build plate and induce compressive stresses that counteract the tensile stresses discussed above. As further discussed below, the process of forming the top region on top of the build plate support region can include peening the support region to induce additional compressive stresses.

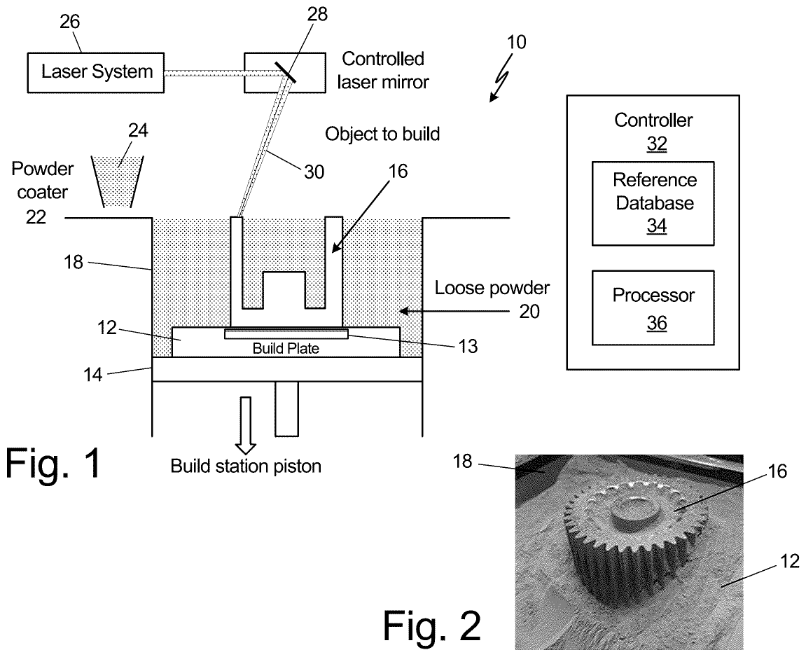

FIG. 1 is a schematic of an exemplary, non-limiting laser powder bed fusion additive manufacturing (PBF-L) system 10. A typical PBF-L system 10 includes a build plate 12, a build station piston 14 that adjusts the height of the build plate 12, a workpiece or part 16 that is built on top of the build plate 12, a powder chamber 18 to contain loose, and unconsolidated build powder 20 that surrounds the workpiece 16. A typical PBF-L system 10 also includes a powder coater 22 that distributes additional build powder 24 over the workpiece 16 after completion of each layer formed on the workpiece 16. A laser system 26 combined with a controlled laser mirror 28 directs a laser beam 30 onto loose build powder 20 to form a melt pool (not shown) that, when solidified, forms a layer of the workpiece 16. As each layer of the workpiece 16 is formed, the build station piston 14 lowers the built plate 12 and workpiece 16 by a predetermined distance that corresponds to the desired thickness of the next layer of the workpiece 16. The powder coater 22 then moves across the top of the loose build powder 20 to distribute a layer of additional build powder 24 that will then be consolidated with the laser beam 30 to form the next layer of the workpiece 16.

Controller 32 controls the height of the build plate 12 by moving the build station piston 14 which in turn controls the thickness of each layer of the workpiece 16. Controller 32 also controls the movement of the powder coater 22 as it distributes additional build powder 24 and the movement of the laser beam 30 as it forms the melt pool that consolidates loose build powder 20 to form each layer of the workpiece 16. For example, the controller 32 controls PBF-L system 10 operating parameters, including:
(1) laser beam power, laser beam velocity, and laser beam spot size, build plate temperature, and layer thickness;
(2) temperature-dependent thermophysical properties of the powder;
(3) feedstock properties including average powder particle size; and
(4) laser hatching strategy including hatch distance, hatch delay time, and stripe width.

Controller 32 typically includes a reference database 34 and processor 36. Reference database 34 contains processing data relevant to the PBF-L system 10, build powder to be used to produce the workpiece 16, and the specific work piece 16 to be produced. Processor 36 contains programming to interface with the reference database 34 to control the PBF-L system 10 to products parts, such as workpiece 16, as is known to a person of ordinary skill in the art. Workpiece 16 can be a near-net-shaped part (i.e., initial production of the part that is very close to the final (net) shape).

The PBF-L system 10 can be used with a variety of build powders to produce workpiece 24 For example the powder can be a metal powder or polymeric powder. Metallic powders compatible with typical PBF-L systems 10 include aluminum, aluminum alloys (e.g., aluminum-lithium alloys), titanium, nickel, nickel alloys, and other metals and alloys known in the art. Polymeric powders compatible with typical PBF-L systems 10 include a wide variety of polymers as known in the art.

As discussed above, thermal loading that occurs during a PBF-L build process induces regions of tensile stress 13 in the build plate 12. The extent of the region of tensile stress 13 can be proportional to the consolidated mass of the workpiece 16, which increases as a build campaign progresses by depositing and consolidating more build powder. The formation of regions of tensile stress 13 in the build plate 12 can lead to build plate warping or failure.

FIG. 2 is a photograph of a part or workpiece 16 made on PBF-L system 10. FIG. 2 also shows powder chamber 18 that contains loose and unconsolidated build powder 20 remaining after the build operation used to make workpiece 16. Once the PBF-L additive manufacturing campaign is complete, the workpiece 16 must be removed from the build plate 12 using appropriate techniques such sawing, wire electrical discharge machining (W-EDM), or other mechanical removal methods. Removing the workpiece 16 from the build plate 12 typically creates defects, such as cracks, fissures, or even holes, that damage the build plate 12. As a result, the build plate 12 must typically be repaired or resurface as discussed below before reuse.

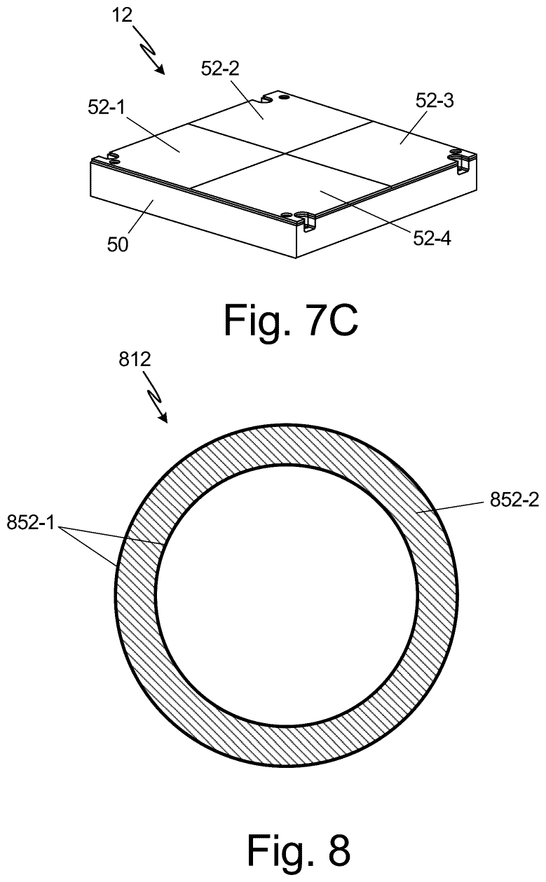

The FSAM process is used to apply a restorative layer of material onto a thinned and/or damaged build plate 12. The restorative layer can be the same material of the build plate 12 and can, in some examples, be sectored to have different material zones over the build plate 12 (see the discussion of FIGS. 7A-7C below). Once the restorative layer has been applied with the disclosed FSAM process, the restorative layer can be machined flat to support the PBF process. In many examples, it will not be necessary to heat treat the restored build plate 12. While the disclosed FSAM process may be particularly useful for larger build plates 12 (e.g., build plates 12 have at least one dimension >400 mm) as those build plates 12 can be expensive, the disclosed FSAM process can be used for build plates 12 of any size.

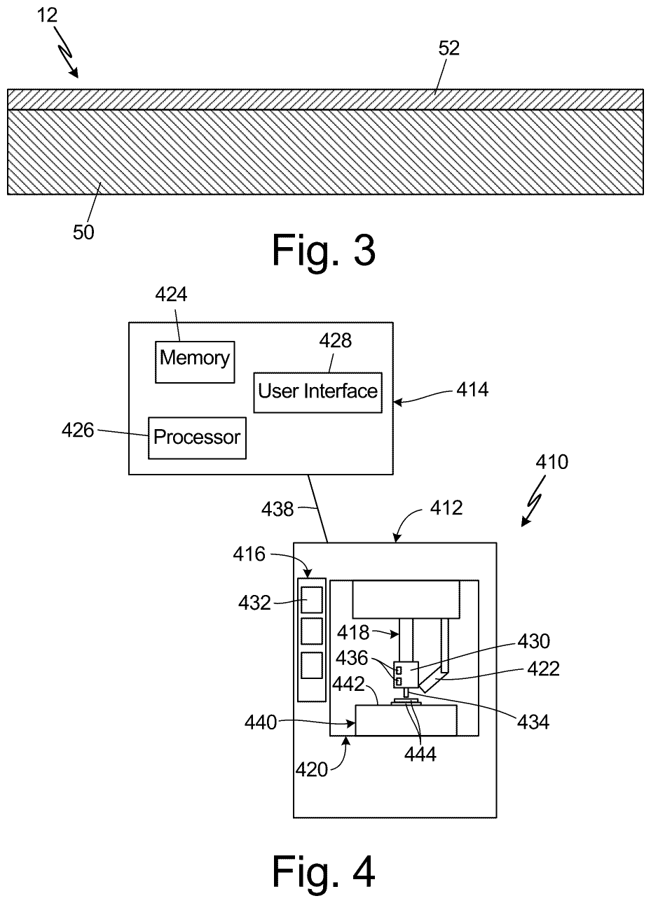

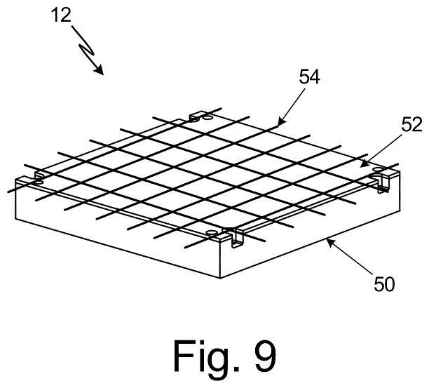

FIG. 3 is a schematic of a build plate 12 that includes a support region 50 and a top region 52, which can become the restorative layer describe above. The support region 50 provides structural support for the build plate 12 and is configured to sit on or be attached to the build station piston 14 of PBF-L system 10. Support region 50 is a metallic structure can be formed from any metallic composition suitable for use in the PBF-L system 10. For example, support region 50 may be formed from aluminum, copper, iron, nickel, titanium, and alloys of those metals, including various steels. In some examples, the support region 50 can be made from a nickel-based alloy such as Inconel 718. The support region 50 can be instrumented (not shown) and/or can include cooling features (see the discussion of FIG. 9 below), such as cooling channels. Top region 52 is a metallic layer deposited on support region 50 using the disclosed FSAM process to induce compressive stresses as discussed in more detail below. Top region 52 is formed from a metal that is metallurgically compatible with the build powder composition used to make a particular workpiece 16 in the PBF-L system 10. For example, if the workpiece 16 is to be made from aluminum, the top region 52 may be aluminum; if the workpiece 16 is to be made from titanium, the top region 52 may be titanium, such as commercially pure titanium. Similarly, if the workpiece 16 is to be made from a nickel-based alloy such as Inconel 718 or another nickel-based alloy, the top region 52 may be a compatible steel or nickel-based alloy, including Inconel 718. As long as the top region 52 is made from a metal that is compatible with the build powder composition used to make a particular build, the support region 50 may be made from any appropriate material. For example, the top region 52 may be commercially pure titanium, aluminum, steel, or nickel-based alloy deposited onto a steel support region 50.

Before the top region 52 is deposited on top of the support region 50, the support region 50 can be subject to a surface preparation operation, followed by peening to induce compressive stresses. The surface preparation and peening operations can be any such operations typically used to prepare a surface to receive a coating. For example, the surface preparation can include one or more of solvent cleaning, grit blasting, grinding, machining, or any other suitable surface preparation step. Grit blasting, grinding, and/or machining or any other surface preparation step can be used to establish a suitable surface roughness to facilitate adhesion of the top region 52. The peening operation can be laser shock peening, shot peening, or any other suitable, similar process.

As discussed, the top region 52 is deposited on top of the support region 50 using a FSAM process as described in more detail below. The FSAM process is based on the plastic deformation of a metallic consumable rod or wire. In one example, the rod is placed in a tool holder that is attached to a milling machine spindle. Frictional heat between the rod and a substrate (e.g., the support region 50) generates a viscoplastic boundary layer at the rod tip. The pressure and temperature conditions of the FSAM process lead to an interdiffusion process that creates a metallic bond (i.e., metallurgic bonding) between the plasticized material from the rod and the substrate (e.g., the support region 50). The FSAM process can be used to produce desired geometry and microstructural gradients in the deposited layer (e.g., the top region 52) as a function of rotating speed, rod linear feed and applied normal load. The deposited layer (e.g., the top region 52) can be machined after deposition using another tool holder in the same tooling magazine of the milling machine. The result is a hybrid additive/subtractive (machining) process that creates, secures, and finishes the top region 52 on the support region 50. Appropriate selection of materials, FSAM deposition parameters, and machining parameters enables the manufacture of a substantially defect-free finished build plate 12 with controlled microstructural gradients and desired mechanical properties, including hardness of the top region 52.

The FSAM process is controlled to prevent the deposited material from melting so the deposition material does not undergo a phase transformation. This allows the microstructure gradient in the deposited material (e.g., the top region 52) to be controlled as a function of the rotating speed, rod linear feed, and applied normal load used during material deposition. The geometrical tolerance and surface finish of the final product is achieved by milling the deposited surface. The FSAM process can produce substantially porosity-free layers with high interfacial bond strength. In some examples, the FSAM process can deposit >two (2) mm layer thickness on a substrate area of 813 mm×203 mm in twenty-four (24) minutes with a feed rate of 254 mm/min and with a rod diameter of 25.4 mm and possible overlap of 1.27 mm if needed. Using a high-speed machining approach, the spindle speed can be twenty-five thousand (25,000) RPM, five (5) mm axial depth of cut, and a chip load of five tenths (0.05) mm/tooth with a three (3) tooth end mill. The machining time for the different features on the surface is less than twenty (20) minutes.

FIG. 4 is a block diagram of exemplary machine system 410 that can be used to implement a FASM process as discussed above. Machine system 410 includes computer numerical control (CNC) machine 412 and computer 414. CNC machine 412 includes tool magazine 416, machine spindle 418, work area 420, and heating element 422. Computer 414 includes memory 424, processor 426, and user interface 428. Tool bank 416 stores subtractive attachments 432 when not in use and can also store additive attachment 430 when not in use. Additive attachment 430 includes wire 434 and sensors 436.

Computer 414 communicates with CNC machine 412 via communication link 438. Communication link 438 can be a wired or wireless connection, and it is understood that computer 414 can be integrated into CNC machine 412 or disposed separately from CNC machine 412. Processor 426, in one example, is a digital logic circuit capable of executing software or other instructions, for example, stored in memory 424.

Memory 424, in some examples, can be configured to store information during operation of computer 414. Memory 424, in some examples, is computer-readable storage media. In some examples, the computer-readable storage media can include a non-transitory medium, and in some examples can include a volatile medium. In some examples, memory 424 is configured to store program instructions for execution by processor 426.

User interface 428, such as a keyboard, touchscreen, monitor, mouse, or other suitable interface device, allows a user to interact with machine system 410, such as by retrieving information from memory 424, receiving notifications, initiating the software stored in memory 424, and inputting additional information to memory 424, among other examples. User interface 428 can also be configured to provide an output of information to the user. For example, user interface 428 can include a sound card, a video graphics card, a speaker, a display device, or other type of device for outputting information in a form understandable to users or machines.

CNC machine 412 is an automated, multi-axis machine tool used to shape workpiece 440 (e.g., top region 52 as deposited onto the support region 50 of build plate 12) into a desired configuration. CNC machine 412 can be a 3-axis machine, a 5-axis machine, or any other desired configuration, for example. Workpiece 440 is housed in work area 420, and CNC machine 412 can use additive attachment 430 and subtractive attachments 432 to deposit workpiece 440 and to shape workpiece 440 into the desired configuration. Substrate 442 (e.g., the support region 50 of built plate 12) is the portion of workpiece 440 onto which layers of material are deposited during the FSAM process.

Tool magazine 416 can store additive attachment 430 and subtractive attachments 432 when not in use. Both additive attachment 430 and subtractive attachments 432 can be connected to and powered by machine spindle 418 and are configured to shape workpiece 440 into the desired configuration. Additive attachment 430 can be configured to add layers 442 of material, such as from wire 434, to substrate 442 through a FSAM process. Sensors 436 can be disposed in or relative to additive attachment 430 and can be configured to sense various operating characteristics of additive attachment 430, such as an applied load, a temperature of wire 434, or any other desired characteristic. Wire 434 can be of any suitable material for applying to substrate 442 through the FSAM process. For example, as discussed above, wire 434 can be aluminum, aluminum alloys, titanium, titanium alloys, a steel, or any other metal or alloy deemed appropriate for a particular application. Wire 434 can be of any desired cross-sectional shape, such as a circle, square, triangle, or any other suitable shape.

Subtractive attachments 432 can remove material from workpiece 440 with any appropriate subtractive manufacturing process, such as through grinding, milling, drilling, or any other substrative manufacturing process deemed appropriate for a particular application. Machine spindle 418 can use both additive attachment 430 and multiple subtractive attachments 432 from tool bank 416, and machine spindle 418 can automatically attach to and detach from both additive attachment 430 and subtractive attachments 432. As such, CNC machine 412 is configured to shape workpiece 440 utilizing various machining attachments and methods.

During an FSAM process, a sacrificial wire or rod of deposition material, such as wire 434 is rotated relative to a substrate, such as substrate 442, and is applied to the substrate with a desired pressure. Friction between the deposition material and the substrate generates heat. The temperature and pressure are controlled, such as by computer 414, to prevent the deposition material from melting and undergoing a phase change. Instead, the heat builds to an FSAM setpoint, which is typically about 70%-90% of the melting point of the deposition material. The FSAM setpoint can be any suitable temperature for plasticizing the deposition material and for providing desired properties at an interface between individual layers, such as layers 444, and at an interface between individual layers and the substrate. Plasticizing the deposition material generates a viscoelastic boundary layer at the tip of the sacrificial wire. The sacrificial wire is then traversed across the substrate and deposits a layer of deposition material on the substrate.

The temperature and pressure conditions during the FSAM process lead to an inter-diffusion process resulting in a metallurgic bond between the plasticized material and the substrate (e.g., the support region 50 of build plate 12) to form the top region 52. Because the sacrificial wire does not melt, the sacrificial wire does not undergo a phase transformation and the microstructure gradient of the deposited wire material on the substrate can thus be controlled as a function of the rotational speed, the applied load, and the traverse speed. FSAM thus enables the generation of substantially defect-free parts with high interfacial shear strength and a controlled microstructure gradient that enhances the mechanical hardness of components produced using FSAM. A heating element, such as heating element 422, can be used to preheat the sacrificial wire such that less friction and pressure are required to raise the temperature of the sacrificial wire to the FSAM setpoint.

During operation, information regarding the desired configuration of workpiece 440 is input into computer 414, such as via user interface 428, and can be stored in memory 424. Processor 426 can execute the instructions stored in memory 424 to cause CNC machine 412 to shape the workpiece 440. Workpiece 440 is placed in work area 420 and CNC machine 412 is activated. Computer 414 instructs CNC machine 412 to select additive attachment 430 or subtractive attachments 432 from tool bank 416. CNC machine 412 maneuvers machine spindle 418 and machine spindle 418 attaches to additive attachment 430 or subtractive attachment 432. Machine spindle 418 powers the selected one of additive attachment 430 and subtractive attachments 432 to deposit material and/or shape workpiece 440.

During operation to deposit material onto substrate 442, computer 414 instructs CNC machine 412 to select additive attachment 430. Machine spindle 418 drives the rotation of additive attachment 430 and positions additive attachment 430 relative to substrate 442. Additive attachment 430 is lowered and wire 434 contacts substrate 442. Machine spindle 418 applies a load to additive attachment 430 thereby applying pressure to wire 434 on substrate 442. When the temperature and pressure of wire 434 are at the FSAM setpoint, which can be sensed by sensors 436, machine spindle 418 traverses relative to workpiece 440 to deposit layers 444 of wire 434 material onto substrate 442. Computer 414 controls the rotational speed of additive attachment 430, the load applied, and the traverse speed of machine spindle 418 relative to workpiece 440.

The microstructure of the layers 444 of wire 434 deposited on substrate 442 can be altered by controlling, for example, the rotating speed, the traverse speed, and the applied load. Sensors 436 can provide feedback to computer 414 to allow computer 414 to adjust the operating parameters of machine spindle 418 to thereby control the properties of layers 444. In some examples, sensors 436 can sense the applied load, the heat generated by the FSAM process, the temperature of wire 434, and the pressure on wire 434, among other parameters. Sensors 436 can communicate the information to computer 414 or can use the information to control various internal components within additive attachment 430. The material of wire 434 and the material of substrate 442 can be stored in memory 424 and computer 414 can control additive attachment 430 to provide a desired microstructure. For example, computer 414 can be loaded with instructions that, when executed by processor 426, cause CNC machine 412 to alter the rotating speed, traverse speed, and applied load to produce a boundary layer with the desired material properties in the deposition zone.

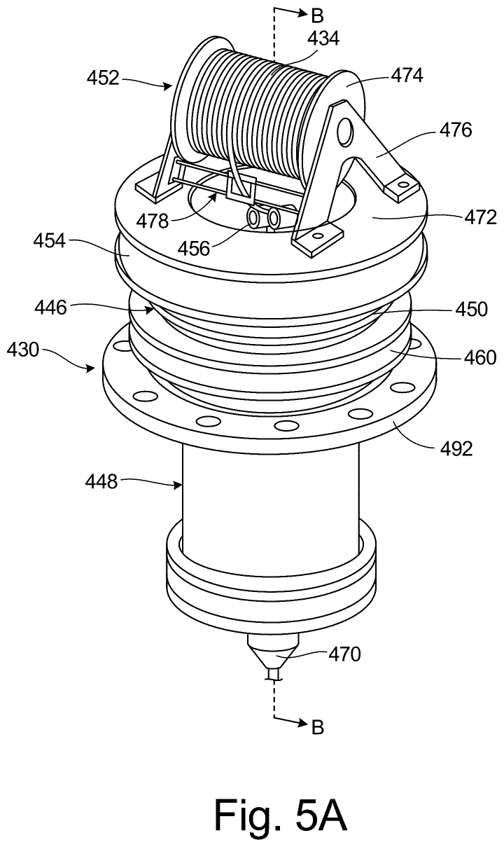

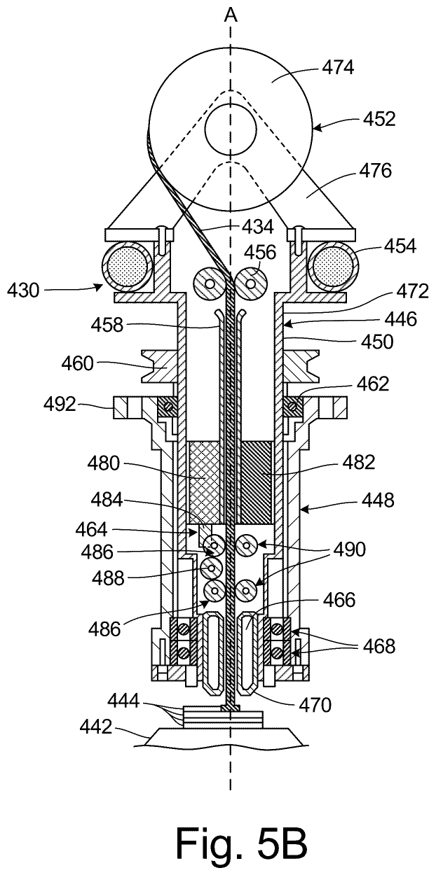

FIG. 5A is a perspective view of additive attachment 430. FIG. 5B is a cross-sectional view of additive attachment 430 taken along line B-B in FIG. 5A. FIGS. 5A and 5B will be discussed together. Additive attachment 430 includes wire 434, rotating assembly 446, and static assembly 448. Rotating assembly 446 includes spindle 450, material supply 452, balance ring 454, guide wheels 456, guide tube 458, drive pulley 460, bearing 462, wire feeder 464, cooling jacket 466, and angular bearings 468. Spindle 450 includes application tip 470 and upper portion 472. Material supply 452 includes reel 474, mount bracket 476, and follower 478. Wire feeder 464 includes motor 480, balance weight 482, transmission gear 484, feeder wheels 486, intermediate gear 488, and idler wheels 490. Static assembly 448 includes mounting flange 492.

Rotating assembly 446 is rotatably mounted on static assembly 448. Mounting flange 492 extends radially from static assembly 448 and can be used to attach additive attachment 430 to a machine for use. Spindle 450 extends through static assembly 448, and application tip 470 projects out of a lower end of static assembly 448. Bearing 462 is disposed between spindle 450 and static assembly 448 and supports rotating assembly 446 for rotation relative to static assembly 448. In some examples, bearing 462 radially supports spindle 450 relative to axis A-A, but it is understood that bearing 462 can provide radial support, axial support, or both. Angular bearings 468 are disposed between spindle 450 and static assembly 448, with angular bearings 468 disposed proximate application tip 470 of spindle 450. Angular bearings 468 can provide both radial and axial support to spindle 450. Balance ring 454 is mounted on spindle 450 below material supply 452 and is configured to absorb vibrations experienced by additive attachment 430, thereby minimizing any adverse effects that can be caused by the vibrations. Drive pulley 460 is mounted on spindle 450 and can receive a device, such as a belt, chain, clamp, or any other suitable device for rotating drive pulley 460 and thus for driving the rotation of rotating assembly 446.

Material supply 452 is mounted on upper portion 472 of spindle 450 outside of static assembly 448. Mount bracket 476 is connected to upper portion 472 of spindle 450, and reel 474 is rotatably supported by mount bracket 476. Similarly, follower 478 is mounted on mount bracket 476, and follower 478 is configured to guide wire 434 between reel 474 and guide wheels 456. Wire 434 wraps around reel 474 and extends from reel 474, through follower 578, and into spindle 450. Wrapping wire 434 on reel 474 provides a feedstock of wire 434 for use throughout the FSAM process, such that the FSAM process does not require stopping and starting to reload additive attachment 430 with additional wire 434. Material supply 452 provides continuous feeding of wire 434 throughout the FSAM process to allow for uninterrupted deposition of layers 444 of wire 434 on substrate 442.

Guide wheels 456 are disposed in upper portion 472 of spindle 450. Guide tube 458 is disposed within spindle 450 and aligned on axis A-A. Guide wheels 456 align wire 434 within spindle 450 as wire 434 enters spindle 450 from material supply 452. Guide tube 458 maintains the alignment of wire 434 within spindle 450 as wire 434 travels between guide wheels 456 and feeder wheels 486.

Wire feeder 464 is disposed within spindle 450 and configured to control the feed of wire 434 through spindle 450. Motor 480 is mounted within spindle 450 and transmission gear 484 is connected to and powered by motor 480. In some examples motor 480 is an electric motor. In some examples, motor 480 is connected to and controlled by computer 414 (shown in FIG. 5). Balance weight 482 is disposed on an opposite side of spindle 450 from motor 480 and is configured to offset a mass of motor 480 to balance spindle 450 during rotation. Transmission gear 484 is connected to and driven by motor 480. Transmission gear 484 meshes with feeder wheels 486 and provides rotational power to feeder wheels 486. Transmission gear 484 can be of any suitable configuration for transmitting power to feeder wheels 486, such as a worm gear, toothed gear, or any other gear deemed suitable for a particular application. While motor 480 is described as providing rotational power through transmission gear 484, it is understood that motor 480 can provide rotational power in any desired manner, such as through a direct connection with one or more feeder wheels 486 or through any desired form of intermediate gear. In some examples, wire feeder 464 includes multiple, intermeshed feeder wheels 486. Where wire feeder 464 includes multiple feeder wheels 486, it is understood that wire feeder 464 can include intermediate gears, such as intermediate gear 488, between feeder wheels 486 to ensure that feeder wheels 486 all rotate in the same direction. Rotating feeder wheels 486 in the same direction allows feeder wheels 486 to exert a downward force on wire 434 to ensure that wire 434 is properly positioned and adequately fed for application throughout any FSAM process. Idler wheels 490 are disposed on an opposite side of wire 434 from feeder wheels 486 and are configured to ensure wire 434 engages feeder wheels 486.

Feeder wheels 486 can engage wire 434 to pull wire 434 through spindle 450 and to resist torquing of wire 434 due to the friction generated between wire 434 and substrate 442. Feeder wheels 486 pull wire 434 from reel 474 and provide wire 434 at tip 470 throughout the FSAM process, thereby ensuring that a continuous supply of wire 434 is available throughout the FSAM process. In some examples, feeder wheels 486 can include teeth to engage wire 434. In some examples, feeder wheels 486 and idler wheels 490 can include intermeshed teeth such that rotation of feeder wheels 486 drives the rotation of idler wheels 490, with wire 434 passing between feeder wheels 486 and idler wheels 490 and engaging a second set of teeth. It is understood, however, that feeder wheels 486 can engage wire 434 in any suitable manner. Feeder wheels 486 engaging wire 434 also provides torque resistance to wire 434 to prevent wire 434 from torquing due to the friction experienced in the FSAM process. Limiting any torquing of wire 434 to the distance between substrate 442 and feeder wheels 486 prevents wire 434 from being damaged by excess torque. Idler wheels 490 maintain the engagement of wire 434 and feeder wheels 486.

Cooling jacket 466 is disposed proximate to tip 470 of spindle 450. After exiting wire feeder 464 wire 434 extends through cooling jacket 466 and exits spindle 450 through tip 470. Cooling jacket 466 can be filled with a cooling substance, such as water, and is positioned to dissipate the heat radiating from wire 434 during the FSAM process. As discussed above, wire 434 is heated to near the melting point of wire 434, such as about 70%-90% of the melting point of wire 434, during the FSAM process. Cooling jacket 466 prevents the heat in wire 434 from radiating into additive attachment 430, which could cause damage to various components of additive attachment 430.

During operation, additive attachment 430 is positioned relative to substrate 442 and spindle 450 is driven to rotate on axis A-A and to apply a layer of wire 434 material on substrate 442. Wire feeder 464 pulls wire 434 from reel 474 and through spindle 450 to position wire 434 outside of tip 470 and into the deposition zone near substrate 442. With spindle 450 rotating on axis A-A, additive attachment 430 is lowered towards substrate 442 and wire 434 is applied to substrate 442 with a desired pressure.

Wire feeder 464 continuously provides additional wire 434 for deposition onto substrate 442. Feeder wheels 486 drive wire 434 towards tip 470 to assist in maintaining the pressure of wire 434 on substrate 442. Feeder wheels 486 pull wire 434 from reel 474 and position the end of wire 434 at tip 470 such that the end of wire 434 is near substrate 442 and positioned to add layers 444 of wire 434 to substrate 442. The feed rate of wire 434 is controlled by motor 480, which supplies rotational power to feeder wheels 486 through transmission gear 484. Transmission gear 484 drives feeder wheels 486, and feeder wheels 486 pull wire 434 from reel 474, through guide wheels 456 and guide tube 458, and push wire 434 out of spindle 450 through tip 470.

The friction and pressure applied to wire 434 cause heat to build at the tip of wire 434. The heat builds until the temperature reaches the FSAM setpoint. Additive attachment 430 traverses substrate 442, and layers 444 of wire 434 are deposited on substrate 442. To generate the heat required to plasticize wire 434 for application during the FSAM process, additive attachment 430 can include a heating element, such as heating element 422 (shown in FIG. 5). The heating element can raise the temperature of wire 434 such that less friction and pressure are required to raise the temperature of wire 434 to the FSAM setpoint. In one example, additive attachment 430 can include an in-situ heating element, such as by conducting electricity through one of feeder wheels 486 or idler wheels 490, to pre-heat wire 434 for application. In some examples, a heating element is disposed outside of additive attachment 430 and focuses energy in the deposition zone to provide additional heat to wire 434. When the temperature of wire 434 reaches the FSAM setpoint, layers 444 can be deposited on substrate 442 through the continued application of pressure and by traversing wire 434 across substrate 442. Layers 444 can be stacked on substrate 442 and can be machined into a final desired form using one or more subtractive attachments 432 as discussed above.

For example, the FSAM process described above can deposit an aluminum, aluminum alloy, titanium, titanium alloy, steel layer, or layer of any other material deemed appropriate for a particular application of 1 mm to 4 mm thick to form the top region 52 on the support region 50 of build plate 12 using an aluminum, aluminum alloy, titanium, titanium alloy, steel, or any other material deemed appropriate for a particular application consumable wire or rod of 25.4 mm diameter using the CNC milling machine 410. The CNC milling marching 410 will continuously feed the wire or rod as it is deposited on the surface of the support region 50 of build plate 12. The wire or rod can have a rotational speed of about 3000 RPM and can be fed in an axial direction to apply a normal force of about 890 N at the start of contact with the support region 50 of build plate 12. As the process advances the normal forces will be reduced to about 445 N. This load will generate a contact pressure of 2.48 MPa on the support region 50 of build plate 12. Frictional heat generated at the interface between the wire or rod and the support region 50 of build plate 12 forms a viscoplastic boundary layer at the wire or rod tip that results in an interdiffusion process that creates a metallic bond between the plasticized deposition material and the support region 50 of build plate 12. The FSAM process can deposit layers that are more than 0.1 mm thick on a substrate area of 813 mm×203 mm in 24 minutes with a feed rate of 254 mm/min and with a step over or an overlap of 1.27 mm between the deposited tracks. Using a high-speed machining approach the deposited layer that forms the top region 52 can be machined to the desired geometrical tolerance and surface finish, for example, with a spindle speed of 24,000 RPM, 1 mm axial depth of cut, and a chip load of 0.05 mm/tooth with 3 teeth end mill. The machining time for the different features on the surface can be less than 24 minutes, resulting in a total production time of 2 to 3 hours, including setup.

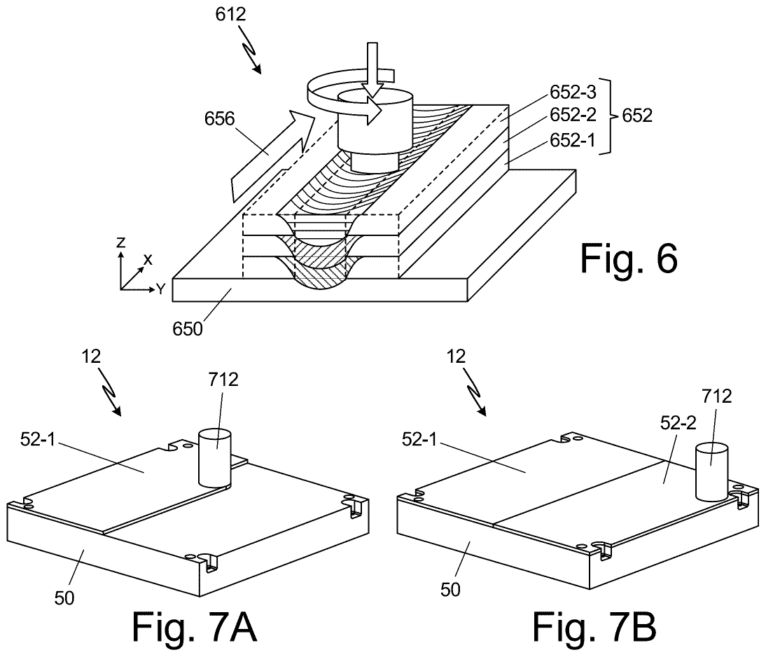

FIG. 6 is another view of the FSAM process described above. CNC machine 612, which is consistent with the CNC machine 412 described above, is configured to traverse support region 650 to deposit one or more layers of top region 652 (e.g., layers 652-1, 652-2, and 652-3). As FIG. 6 shows, CNC machine 612 moves in a weld direction 656 over the one or more layers of top region 652 to deposit the one or more layers of top region 652. In some examples end portions 658 of the one or more layers of top region 652 can be machined after the FSAM process is concluded to provide a desired geometry.

FIG. 7A shows build plate 12 with a top region 52-1 of a first material being deposited on a support region 50 with a CNC machine 712. FIG. 7B shows build plate 12 with a top region 52-1 of a first material and top region 52-2 of a second material being deposited on a support region 50 with a CNC machine 712. FIG. 7C shows build plate 12 with a top region 52-1 of a first material, a top region 52-2 of a second material, at top region 52-3 of a third material, and a top region 52-4 of a fourth material. Using dissimilar metals as one or more of the FSAM deposited top regions 52-1, 52-2, 52-3, and 52-4 can introduce new design spaces and support novel PBF-L machine architecture. For example, this capability could be included in an annular build plate 812 as shown in FIG. 8. Such a build plate 812 can include bands of different materials 852-1, 852-2 positioned based on the components that will be built from them. The applied materials 852-1, 852-2 can also be selected a function of mechanical properties of the feedstock. There may be instances where there are greater tensile forces due to distortion of large monolithic parts and locally applying an FSAM layer would optimize process planning.

FIG. 9 is a schematic of a build plate 12 that includes a support region 50 and a top region 52 as discussed above. The build plate 12 also includes temperature control features 54 that are configured to provide thermal management to the build plate 12. Thermal management features 54 can be any structures that can be embedded in the top region 54 to remove or add heat to the top region 52 when the PBF-L system 10 is in operation. In some applications, the thermal management features 54 can be tubes or traces made from a thermally conductive material (e.g., copper, aluminum, etc.) that are positioned to be embedded in the top region 54 when the top region is deposited with a FSAM process as described above. The thermal management features 54 should be configured to facilitate heat transfer out of or into the build plate to or from an external sink (not shown).

As build plates continue to get larger (e.g., with at least one dimension of 600 mm+) they will be considered more of a capital asset and less of a consumable. FSAM can be used to restore the plates and provide additional capabilities by having multi-material build plates.

The top region 52 can be deposited as a layer of any desirable thickness on the support region 50. For example, the top region 52 can be between 0.020 inches (0.51 mm) and 0.030 inches (0.76 mm) thick. Depending on the application, the top region 52 can be applied over the entire support region 50 such that the top region 52 and support region 50 have the same surface area. In other applications, the top region 52 can be applied over less than the entire support region 50 such that the top region 52 has a smaller surface area than the support region 50. Creating a top region 52 having a smaller surface area than the support region 50 can be desirable as a cost-saving measure (i.e., a smaller top region 52 requires less material) or as a way to reuse less than all of the surface area of the support region 50 when refurbishing a build plate 12 that has previously been used in a PBF-L additive manufacturing campaign.

Following deposition of the top region 52 on the support region 50, the top region 52 can be ground or machined flat to achieve a desirable surface for a PBF-L additive manufacturing campaign. In some applications, the top region 52 can be further finished by polishing it with a laser in the PBF-L additive manufacturing system before starting a PBF-L additive manufacturing campaign. If performed, the polishing step can be accomplished by selecting suitable laser parameters, such as laser beam power, laser beam velocity, and laser beam spot size.

The build plate 12 of the present disclosure can either be a new, unused built plate or a build plate previously used in a PBF-L additive manufacturing campaign (e.g., a first PBF-L additive manufacturing campaign). If the build plate 12 was previously used in a PBF-L additive manufacturing campaign, it likely needs some amount of repair due to defects that form as a result of removing builds or workpieces from the PBF-L additive manufacturing campaign. The defects can be cracks, fissures, or even holes that form from the mechanical methods used to remove builds or workpieces. The repairs can be any methods typically used to repair such defects in a structure such as build plate 12. For examples, the defects can be filled with filler material, ground out, or repaired with any combination of suitable techniques. Following repair to the build plate 12, the build plate 12 can serve as the support region 50 upon which the top region 52 is deposited as discussed above. Once complete, the build plate 12 can be installed in the PBF-L additive manufacturing system 10 before build powder is deposited on top of the top region 52 to start another PBF-L additive manufacturing campaign (e.g., a second PBF-L additive manufacturing campaign).

The build plate and method for preparing the build plate for use in a PBF-L additive manufacturing system addresses the tensile stresses induced during a PBF-L additive manufacturing campaign by introducing countervailing compressive stresses into the build plate. This allows the build plate to sustain forces from the tensile stresses without exhibiting damage (e.g., spallation and delamination) that often occurs during PBF-L additive manufacturing campaigns. In addition, the use of top region on top of a build plate support region facilitates the reuse of build plates following a PBF-L additive manufacturing campaign. Further, this feature can reduce the cost of PBF-L additive manufacturing campaigns by allowing the top region to be metallurgically matched to the composition of the build or workpiece to be made during a PBF-L additive manufacturing campaign while using a less expensive material for the build plate support region.

### Discussion of Possible Embodiments

The following are non-exclusive descriptions of possible embodiments of the present invention.

A build plate for a PBF-L additive manufacturing system, comprising a build plate having a support region and a top region, wherein the top region is formed on the support region by a friction surfacing additive manufacturing (FSAM) process such that the top region is under a compressive stress.

The build plate of the preceding paragraph can optionally include, additionally and/or alternatively, any one or more of the following features, configurations and/or additional elements:
A further embodiment of the foregoing build plate, wherein the support region and top region are formed from the same material.

A further embodiment of any of the foregoing build plates, wherein the support region and top region are formed from different materials.

A further embodiment of any of the foregoing build plates, wherein the support region is formed from steel and the top region is formed from commercially pure titanium, aluminum, steel, or nickel-based alloy.

A further embodiment of any of the foregoing build plates, wherein the top region is between 0.020 inches and. 030 inches thick.

A further embodiment of any of the foregoing build plates, wherein the top region has a surface area that is the same as a surface area of the support region.

A further embodiment of any of the foregoing build plates, wherein the top region has a surface area that is smaller than a surface area of the support region.

A method of preparing a build plate for use in a PBF-L additive manufacturing system, comprising preparing a support region of the build plate to receive a top region; depositing, using a FSAM process, a layer of metal on the support region, wherein the layer of metal forms the top region and the layer of metal is formed with a compressive stress; and machining to top region to provide a desired surface roughness.

The method of preparing a build plate of the preceding paragraph can optionally include, additionally and/or alternatively, any one or more of the following features, configurations and/or additional elements:
A further embodiment of the foregoing method of preparing a build plate, wherein the support region and top region are formed from the same material.

A further embodiment of any of the foregoing methods of preparing a build plate, wherein the support region and top region are formed from different materials.

A further embodiment of any of the foregoing methods of preparing a build plate, wherein the support region is formed from steel and the top region is formed from commercially pure titanium, aluminum, steel, or nickel-based alloy.

A further embodiment of any of the foregoing methods of preparing a build plate, wherein the top region is between 0.020 inches and. 030 inches thick.

A further embodiment of any of the foregoing methods of preparing a build plate, wherein the top region has a surface area that is the same as a surface area of the support region.

A further embodiment of any of the foregoing methods of preparing a build plate, wherein the top region has a surface area that is smaller than a surface area of the support region.

A further embodiment of any of the foregoing methods of preparing a build plate, wherein the build plate is installed in the PBF-L additive manufacturing system and the top region is polished by a laser in the PBF-L additive manufacturing system before build powder is deposited on top of the top region.

A further embodiment of any of the foregoing methods of preparing a build plate, wherein preparing a support region of the build plate to receive a top region comprises removing from the build plate one or more builds formed on the build plate during a first PBF-L additive manufacturing campaign to expose the support region; and repairing any defects formed in the build plate as a result of removing the one or more builds from the build plate.

A method of preparing a build plate for use in a PBF-L additive manufacturing system, comprising removing from the build plate one or more builds formed on the build plate during a first PBF-L additive manufacturing campaign to expose a support region; repairing any defects formed in the build plate as a result of removing the one or more builds from the build plate; preparing the support region of the build plate to receive a top region; depositing, using a FSAM process, a layer of metal on the support region, wherein the layer of metal forms the top region such that the top region is between 0.020 inches and 0.030 inches thick and the top region is formed with a compressive stress; machining to top region to provide a desired surface roughness; and installing the build plate the PBF-L additive manufacturing system.

The method of preparing a build plate of the preceding paragraph can optionally include, additionally and/or alternatively, any one or more of the following features, configurations and/or additional elements:
A further embodiment of the foregoing method of preparing a build plate, wherein the support region and top region are formed from the same material.

A further embodiment of any of the foregoing methods of preparing a build plate, wherein the support region and top region are formed from different materials.

A further embodiment of any of the foregoing methods of preparing a build plate, wherein the support region is formed from steel and the top region is formed from commercially pure titanium, aluminum, steel, or nickel-based alloy.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A build plate for a powder bed fusion-laser (PBF-L) additive manufacturing system, comprising:
a build plate having a support region and a top region, wherein the top region is formed on the support region by a friction surfacing additive manufacturing (FSAM) process such that the top region is under a compressive stress.

2. The build plate of claim 1, wherein the support region and top region are formed from the same material.

3. The build plate of claim 1, wherein the support region and top region are formed from different materials.

4. The build plate of claim 1, wherein the support region is formed from steel and the top region is formed from commercially pure titanium, aluminum, steel, or nickel-based alloy.

5. The build plate of claim 1, wherein the top region is between 0.020 inches and 0.030 inches thick.

6. The build plate of claim 1, wherein the top region has a surface area that is the same as a surface area of the support region.

7. The build plate of claim 1, wherein the top region has a surface area that is smaller than a surface area of the support region.

8. A method of preparing a build plate for use in a powder bed fusion-laser (PBF-L) additive manufacturing system, comprising:
preparing a support region of the build plate to receive a top region;
depositing, using a friction surfacing additive manufacturing (FSAM) process, a layer of metal on the support region, wherein the layer of metal forms the top region and the layer of metal is formed with a compressive stress; and
machining to top region to provide a desired surface roughness.

9. The method of claim 8, wherein the support region and top region are formed from the same material.

10. The method of claim 8, wherein the support region and top region are formed from different materials.

11. The method of claim 8, wherein the support region is formed from steel and the top region is formed from commercially pure titanium, aluminum, steel, or nickel-based alloy.

12. The method of claim 8, wherein the top region is between 0.020 inches and. 030 inches thick.

13. The method of claim 8, wherein the top region has a surface area that is the same as a surface area of the support region.

14. The method of claim 8, wherein the top region has a surface area that is smaller than a surface area of the support region.

15. The method of claim 8, wherein the build plate is installed in the PBF-L additive manufacturing system and the top region is polished by a laser in the PBF-L additive manufacturing system before build powder is deposited on top of the top region.

16. The method of claim 8, wherein preparing a support region of the build plate to receive a top region comprises:
removing from the build plate one or more builds formed on the build plate during a first PBF-L additive manufacturing campaign to expose the support region; and
repairing any defects formed in the build plate as a result of removing the one or more builds from the build plate.

17. A method of preparing a build plate for use in a powder bed fusion-laser (PBF-L) additive manufacturing system, comprising:
removing from the build plate one or more builds formed on the build plate during a first PBF-L additive manufacturing campaign to expose a support region;
repairing any defects formed in the build plate as a result of removing the one or more builds from the build plate;
preparing the support region of the build plate to receive a top region;
depositing, using a friction surfacing additive manufacturing (FSAM) process, a layer of metal on the support region, wherein the layer of metal forms the top region such that the top region is between 0.020 inches and 0.030 inches thick and the top region is formed with a compressive stress;
machining to top region to provide a desired surface roughness; and
installing the build plate the PBF-L additive manufacturing system.

18. The method of claim 17, wherein the support region and top region are formed from the same material.

19. The method of claim 17, wherein the support region and top region are formed from different materials.

20. The method of claim 17, wherein the support region is formed from steel and the top region is formed from commercially pure titanium, aluminum, steel, or nickel-based alloy.
